(19) United States
(12) Patent Application Publication
(10) Pub. No.: US 2008/0164683 A1
(43) Pub. Date: Jul. 10, 2008

(54) Handle assembly for raising and lowering landing gear

(76) Inventor: Sean E. VanDenberg, Canal Fulton, OH (US)

Correspondence Address: SAND & SEBOLT, AEGIS TOWER, SUITE 1100, 4940 MUNSON STREET, NW, CANTON, OH, 44718-3615, US

(21) Appl. No.: 11/649,482

(22) Filed: Jan. 4, 2007

(51) Int. Cl. B60S 9/02

(52) U.S. Cl. 280/766.1

(57) ABSTRACT

A handle for rotating an input shaft of a landing gear defines an elongated slot, and a rod extends through a hole in the input shaft and through the slot so that the rod is slidable within the slot in its elongated direction between a disengaged position and an engaged position. Preferably, the handle defines a non-circular opening for receiving and engaging therewithin a non-circular outer portion of the input shaft in the engaged position. Preferably, the slot includes first and second sections, and a lug is connected to the rod and fits within the first section of the slot and not within the second section so that the lug when in the first section locks the rod in the engaged position. The lug is preferably spring biased into the first section to automatically lock the rod when the handle is pivoted from a stowed position to an operational position.

### BACKGROUND OF THE INVENTION

1. Technical Field

The present invention relates generally to landing gear for trailer assemblies. More particularly, the invention relates to crank handles for such landing gear. Specifically, the invention relates to such a crank handle which positively locks into the crank position onto the input shaft of the landing gear and is easily releasable from its locked position on the input shaft.

2. Background Information

Crank handles for rotating the input shaft of landing gear assemblies are well known in the art. However, standard crank handles are often somewhat sloppy and present safety issues as well. There have been improvements to crank handles such as ratcheting mechanisms which allow for the handle to be situated in more desirable positions as well as handles which automatically lock to the input shaft in the operational position. However, there remains room for improvement in the art and, in particular, for a simple configuration which provides several advantages over the standard handle.

### BRIEF SUMMARY OF THE INVENTION

The present invention provides a landing gear comprising a telescoping leg; an input shaft rotatably connected to the leg; a handle; a first connection for connecting the handle to the input shaft that provides for a sliding engagement therebetween; and a locking mechanism having an unlocked position in which the handle is slidable between first and second positions and a locked position in which the handle is secured in the first position to prevent the handle from moving to the second position.

### BRIEF DESCRIPTION OF THE SEVERAL VIEWS OF THE DRAWINGS

FIG. 1 is a fragmentary sided elevational view showing the handle assembly of the present invention mounted on the landing gear of a trailer.

FIG. 2 is an exploded perspective view of the inner end of the handle assembly and the outer end of the input shaft of the landing gear.

FIG. 3 is a top plan view showing a portion of the frame of the trailer with the landing gear mounted thereon and the handle assembly in the stowed position.

FIG. 4 is similar to FIG. 3 and shows the handle moving out of the stowed position.

FIG. 5 is a top plan view similar to FIG. 4 which shows a smaller portion of the trailer frame and the inner end of the handle in the unlocked position.

FIG. 6 is a sectional view taken on line 6-6 of FIG. 5.

FIG. 7 is a sectional view taken on line 7-7 of FIG. 6.

FIG. 8 is a sectional view taken on line 8-8 of FIG. 6.

FIG. 9 is similar to FIG. 5 and shows the handle having moved to the locked position.

FIG. 10 is a sectional view taken on line 10-10 of FIG. 9.

FIG. 11 is a sectional view taken on line 11-11 of FIG. 10.

FIG. 12 is a sectional view taken on line 12-12 of FIG. 10.

FIG. 13 is similar to FIG. 1 and shows the handle assembly in its operational and locked position rotating to lower the landing gear.

Similar numbers refer to similar parts throughout the drawings.

### DETAILED DESCRIPTION OF THE INVENTION

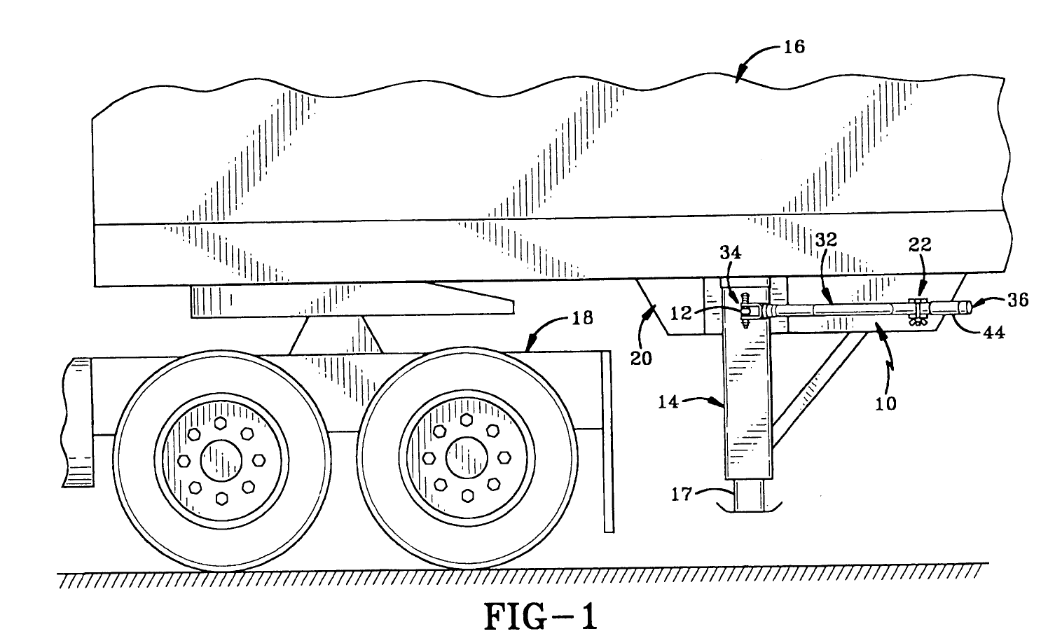

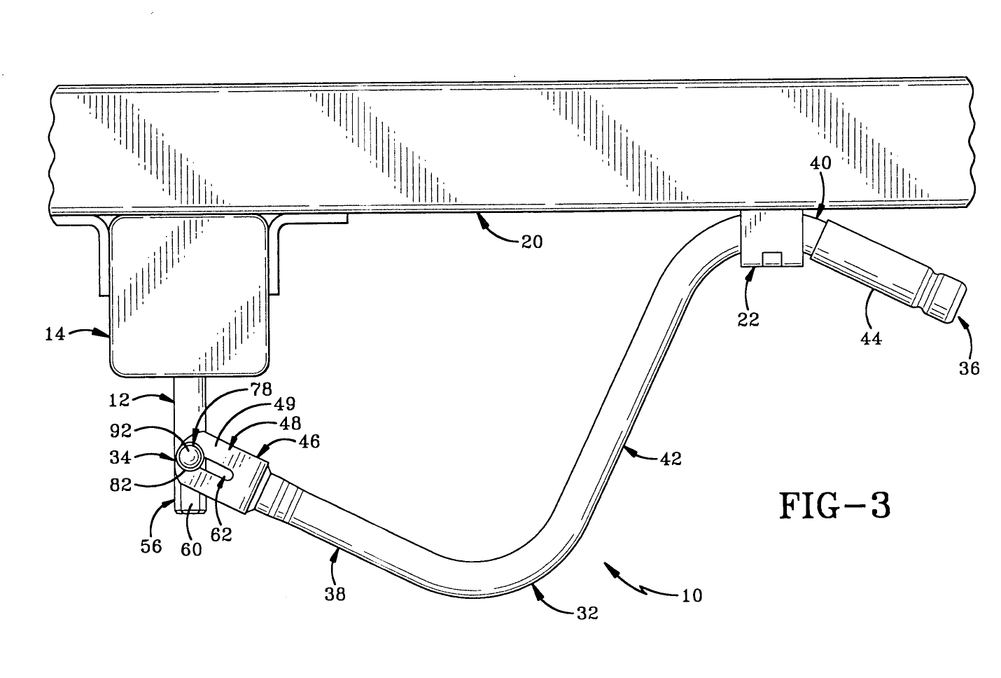

The handle assembly of the present invention is shown generally at 10 in FIGS. 1-3. Referring to FIG. 1, handle assembly 10 is mounted on an input shaft 12 of a landing gear 14 of trailer 16 and is rotatable to rotate input shaft 12 in order to lower and raise telescoping legs 17 of landing gear 14. Trailer 16 is shown in FIG. 1 coupled via a fifth-wheel to a towing vehicle 18. Trailer 16 includes a frame 20 on which landing gear 14 is mounted. A securing mechanism 22 is mounted on frame 20 for securing assembly 10 in a stowed position, as shown in FIGS. 1 and 3. Assembly 10 includes a handle 32 having an inner end 34 adjacent which handle 32 is mounted on input shaft 12 and an outer end 36 adjacent which handle 32 is secured via mechanism 22 in the stowed position.

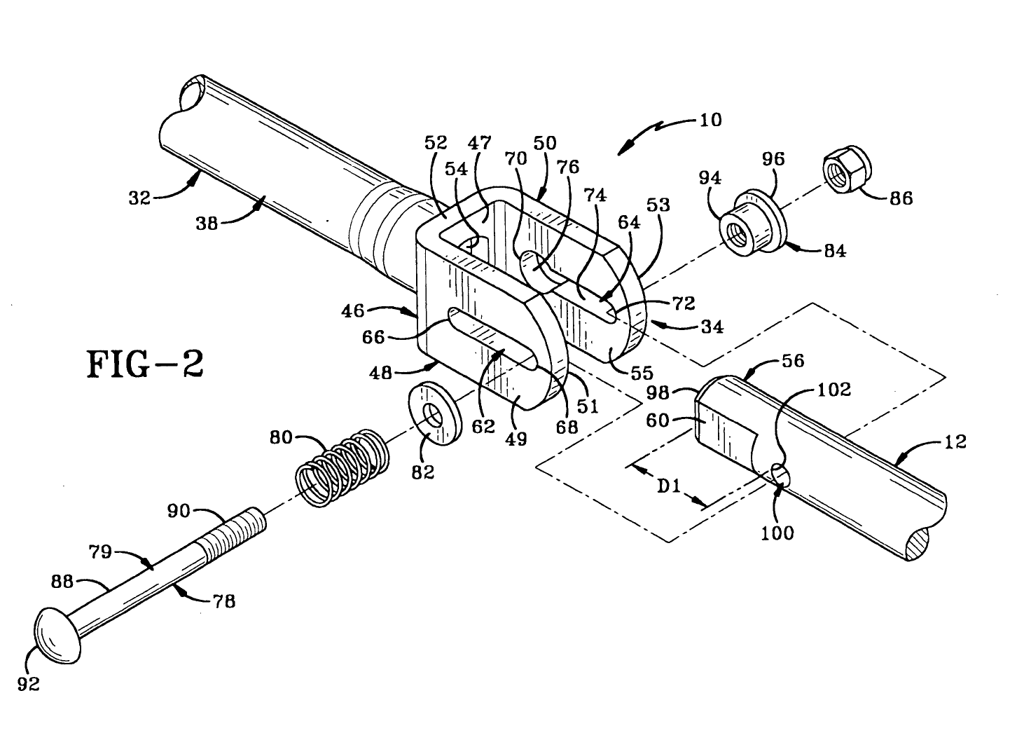

Referring to FIGS. 2 and 3, assembly 10 is further described. As seen in FIG. 3, handle 32 is a generally S-shaped member. Handle 32 is typically formed of a hollow, tubular member which has a first straight segment 38 adjacent inner end 34, a second straight segment 40 which is adjacent outer end 32 and is parallel to first straight segment 38 and a third straight segment 42, which extends perpendicularly to and between first and second segments 38 and 40 and is connected thereto by curving portions of the tubular member. A grip 44 is rotatably mounted on second segment 40.

Referring to FIG. 2, handle 32 includes a U-shaped clevis 46 having first and second spaced legs 48 and 50 which extend from an intervening base 52 and are parallel to one another. First leg 48 has outer and inner opposed surfaces 49 and 51. Likewise, second leg 50 has outer and inner opposed surfaces 53 and 55. Base 52 defines a non-circular opening 54 for receiving a non-circular outer portion 56 of input shaft 12. Opening 54 is of a mating configuration with outer portion 56 and more particularly include an engagement portion in the form of opposed flat surfaces 58 (FIGS. 7 and 12) which are engageable with opposed flats 60 (FIG. 12) of outer portion 56 for applying torque thereto during rotation of handle 32. Thus, the engagement portion and the outer portion at the engagement therebetween do not have circular configurations which are concentric about the axis about which the input shaft and handle rotate.

First leg of 48 of clevis 46 defines a straight elongated slot 62 and second leg 50 defines an elongated keyhole-shaped second slot 64. More particularly, first slot 62 has first and second ends 66 and 68 defining therebetween an elongated direction of the slot, which is parallel to the elongated direction of first segment 38 of handle 32. Slot 62 has a constant width between ends 66 and 68 except for the rounded end portions thereof. Second slot 64 also has first and second ends 70 and 72 defining therebetween an elongated direction thereof. Slot 64 includes a narrower section 74 and a wider section 76 in communication with one another. Narrower section 74 has a constant width which is the same as that of first slot 62. Wider section 76 has a width which is greater than that of section 74 and more particularly has a circular shape.

Handle assembly 10 further includes a carriage bolt 78, a coil spring 80, a washer 82, a lug-washer combination 84 and a locking nut 86. Bolt 78 includes a rod or shaft 79 which includes a non-threaded portion 88 and a threaded portion 90 adjacent one end thereof. Bolt 78 also includes an enlarged head 92 which is connected to non-threaded portion 88 at the end opposite threaded portion 90. Combination 84 includes a lug 94 and a washer 96 which are integrally formed as a one-piece member. Each of combination 84 and nut 86 are internally threaded to threadably engage threaded section 90 of bolt 78.

With continued reference to FIG. 2, input shaft 12 has an outer end 98 and defines a through hole 100 such that outer portion 56 is disposed between end 98 and hole 100. When assembly 10 is assembled and mounted on input shaft 12, shaft 79 of bolt 78 passes sequentially through spring 80, washer 82, first slot 62, hole 100, second slot 64, combination 84 and nut 86. Preferably lug 94 is fully threaded on threaded portion 90 of bolt 78 to abut non-threaded portion 88. Nut 86 is threaded onto section 90 and abuts washer 96 to lock combination 84 onto bolt 78.

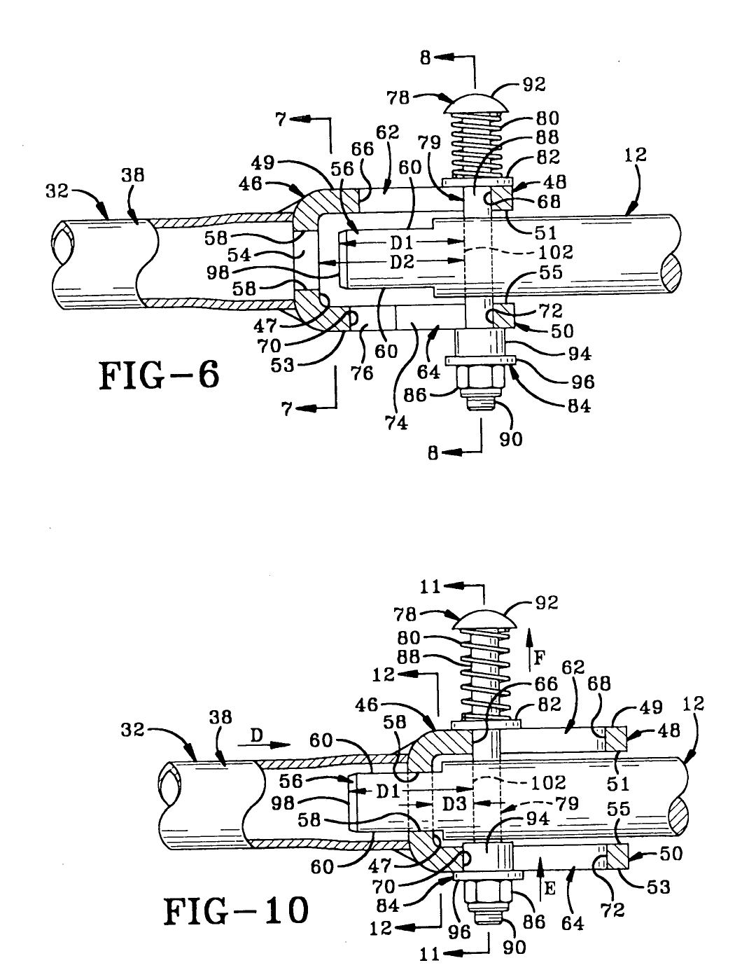

Hole 100 is bounded by an inwardly-facing surface 102 of shaft 12 which is closest to outer end 98. Outer end 98 and surface 102 define therebetween a distance D1 (FIGS. 2, 6 and 10). Base 52 has an inwardly-facing surface 47 from which opening 54 extends outwardly toward segment 38. Surface 47 is flat and substantially vertical when assembly 10 is mounted on input shaft 12. When handle 32 is in the disengaged and unlocked position (FIG. 6), surface 47 of base 52 and the portion of rod 79 closest to surface 47 define therebetween a distance D2 which is greater than distance D1. When handle 32 is in the engaged and locked positions (FIG. 10), the corresponding distance D3 between surface 47 and rod 79 is less than distance D1.

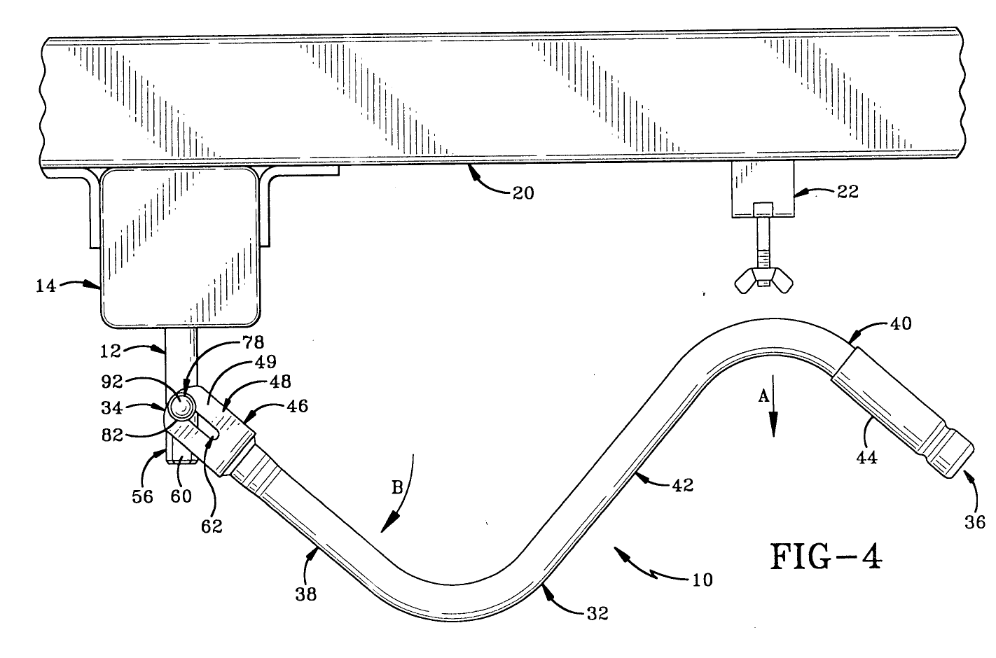

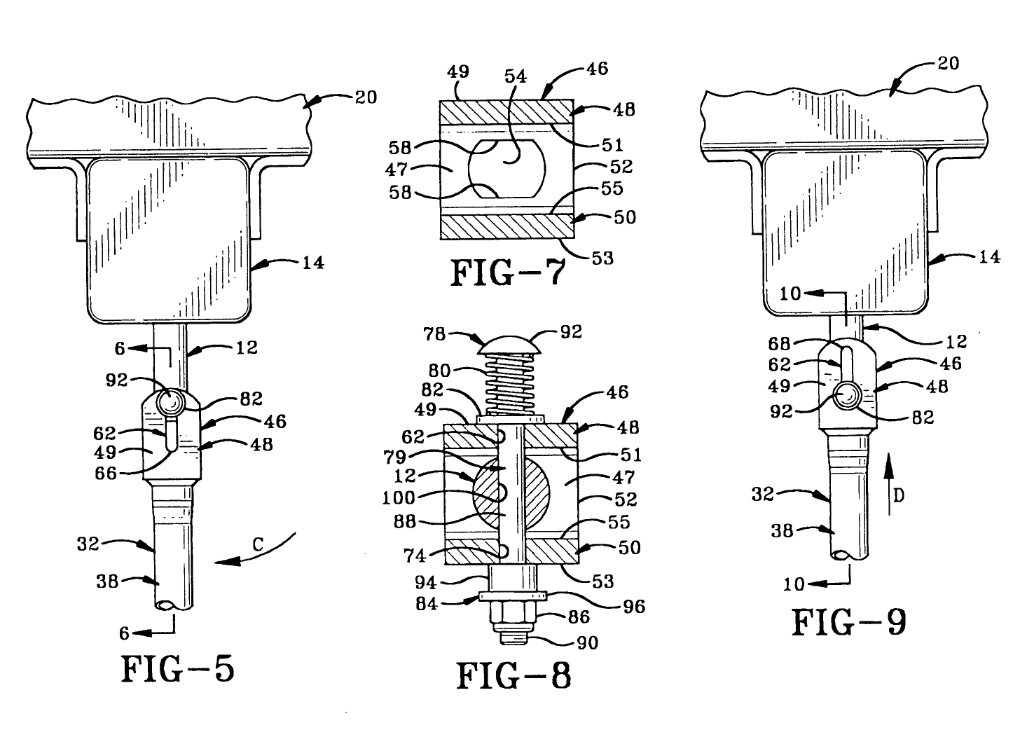

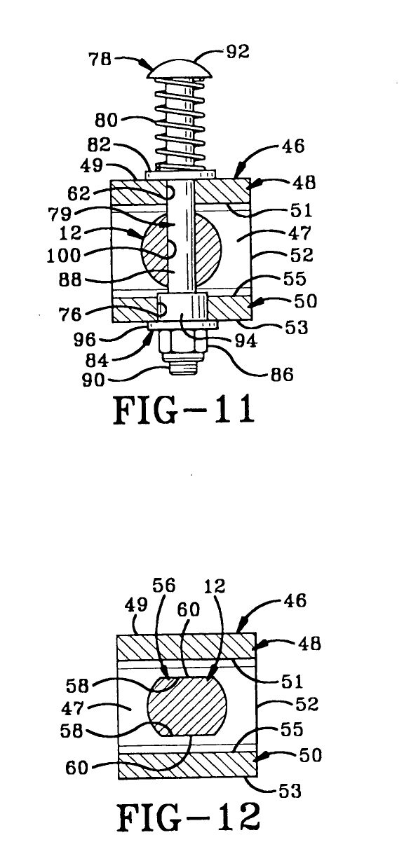

The operation of assembly 10 is now described with reference to FIGS. 3-13. FIG. 3 shows handle 32 assembled and pivotally mounted on input shaft 12 via bolt 78, which thus serves in part as a pivot. FIG. 3 shows handle 32 in the stowed position. As shown in FIG. 4, securing mechanism 22 has released handle 32, which moves outwardly (Arrow A) from frame 20 of trailer 16 in a pivoting fashion (Arrow B) about bolt 78. FIG. 5 shows handle 32 further pivoted out (Arrow C) so that first segment 38 is aligned with and parallel to input shaft 12. More particularly, opening 54 is aligned with outer portion 56 of input shaft 12. FIGS. 5-8 illustrate a first or disengaged position in which outer portion 56 is outside of opening 54 and shaft 79 of bolt 78 is disposed adjacent second end 68 of slot 62 and second end 72 of slot 64. Thus, shaft 79 is disposed in narrow section 74 of second slot 64.

As shown in FIG. 9, handle 32 is moved inwardly along input shaft 12 so that segment 38 moves as indicated at Arrow D in FIG. 9 parallel to input shaft 12. This movement causes outer portion 56 to pass through opening 54 with flats 60 closely adjacent or abutting flat portions 58. FIGS. 9-12 thus illustrate an engaged position in which flats 60 engage flat portions 58 to provide a relatively tight engagement for rotating input shaft 12. In the engaged position, shaft 79 of bolt 78 is disposed adjacent end 66 of first slot 62 and first end 70 of second slot 64. The movement of handle 32 as shown in FIG. 9 positions bolt 78 and combination 84 so that lug 94 moves into wider section 76 of second slot 64 as indicated at Arrow E in FIG. 10 as bolt 78 moves in the same direction as indicated by Arrow F in FIG. 10. More particularly, bolt 78 and the members attached thereto move perpendicularly to input shaft 12 and segment 38 of handle 32, which is also perpendicular to the movement of segment 38 shown in FIGS. 9 and 10 at Arrow D. Spring 80 thus serves as an actuator for moving bolt 78 and combination 84 in directions indicated at Arrows E and F and also biases them to and retains them in the locked position shown in FIGS. 9-12. During movement of handle 32 from the unlocked position (FIG. 6) to the locked position (FIG. 10), washer 82 slidably engages outer surface 49 of first leg 48 and lug 94 slidably engages outer surface 53 of second leg 50 until lug 94 snaps into wider section 76 of second slot 64 at which time washer 96 of combination 84 engages outer surface 53 of second leg 50, thus serving as a stop to prevent further movement of bolt 78 and combination 84 in the direction indicated by Arrows E and F in FIG. 10. Movement of handle 32 from the unlocked to the locked position is easily achieved without creating a force which would shift landing gear 14 into or out of high or low gear. In the locked position, lug 94 and a portion of second leg 50 adjacent the intersection of narrower and wider sections 74 and 76 of second slot 64 provide an interference which prevents handle 38 from moving outwardly in the direction opposite of that shown by Arrow D in FIGS. 9 and 10.

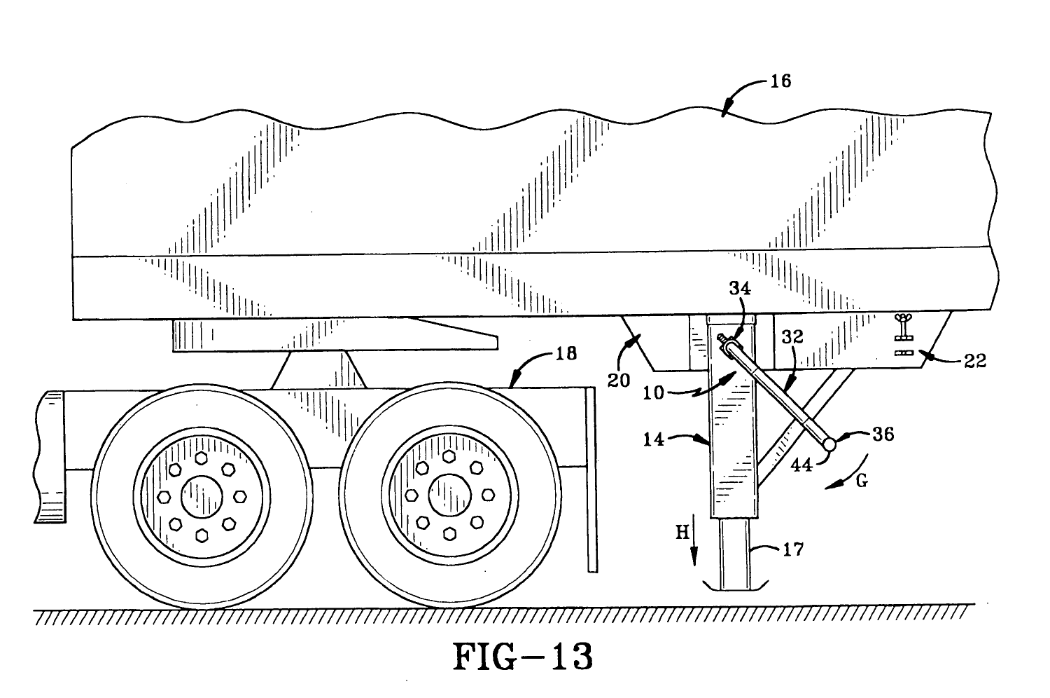

Once handle 32 has been moved to the locked position, it can then be rotated as shown in FIG. 13 at Arrow G to lower leg 17 as indicated at Arrow H and rotated in the opposite direction to raise leg 17. Conveniently, the locked position prevents handle 32 from sliding off of input shaft 12, which provides additional safety and also allows for easy shifting between high and low gears (not shown) of landing gear 14. The shifting of said gears is achieved by pushing or pulling on shaft 12. To return handle 32 from the operational position to the stowed position, the operator simply applies a force on head 92 of bolt 78 in the direction opposite that shown by Arrow F in FIG. 10 to compress spring 80 and move lug 94 out of wider section 76 of second slot 64, at which time handle 32 is pulled outwardly in the direction opposite that shown by Arrow D in FIG. 10 to move to the unlocked and disengaged positions shown in FIG. 6. Movement of handle 32 from the locked to the unlocked position is easily achieved without creating a force which would shift landing 14 into or out of high or low gear. Handle 32 is then pivoted about bolt 78 when disposed in narrower section 74 of second slot 64 to the stowed position shown in FIG. 3 with securing mechanism 22 securing handle 32 in the stowed position. Handle assembly 10 thus provides a simple and effective crank for a landing gear which easily moves between unlocked and locked positions wherein the locked position prevents the handle from slipping off the input shaft of the landing gear. This is accomplished with a minimal number of parts, all of which are notably very simple in form.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A landing gear comprising:
a telescoping leg;
an input shaft rotatably connected to the leg;
a handle;
a first connection for connecting the handle to the input shaft that provides for a sliding engagement therebetween; and
a locking mechanism having an unlocked position in which the handle is slidable between first and second positions and a locked position in which the handle is secured in the first position to prevent the handle from moving to the second position.

2. The landing gear of claim 1 wherein the handle is pivotally mounted on the input shaft.

3. The landing gear of claim 1 wherein the locking mechanism comprises a locking member which engages one of the input shaft and handle when the handle is in the first position to create an interference between the locking member and the one of the input shaft and handle to prevent the handle from moving to the second position.

4. The landing gear of claim 1 wherein the locking mechanism comprises a spring for biasing the locking mechanism to the locked position.

5. The landing gear of claim 1 wherein one of the input shaft and handle defines a first slot which is elongated in a first direction; and further comprising a rod extending through the first slot; wherein the handle is slidable between the first and second engaged positions in the first direction with the rod disposed in the first slot.

6. The landing gear of claim 5 wherein the other of the input shaft and the handle defines a hole through which the rod extends.

7. The landing gear of claim 5 wherein the rod is elongated in a second direction transverse to the first direction; and the rod is slidable within the slot in the second direction between the locked and unlocked positions.

8. The landing gear of claim 7 further comprising a spring which biases the rod toward the locked position.

9. The landing gear of claim 7 further comprising a retaining mechanism for retaining the rod in the locked position.

10. The landing gear of claim 7 further comprising a lug connected to the rod; wherein the first slot comprises first and second sections in communication with one another; the lug is configured to fit within the first section and not fit within the second section; and the lug is disposed in the first section in the locked position.

11. The landing gear of claim 10 wherein the first section is a wider section and the second section is a narrower section.

12. The landing gear of claim 11 further comprising a stop connected to the lug and wider than the first section of the slot; and wherein the stop engages the one of the input shaft and handle defining the first slot to position the lug within the first section.

13. The landing gear of claim 10 further comprising a biasing mechanism for biasing the lug toward a position within the first section of the slot.

14. The landing gear of claim 10 wherein the lug slidably engages one of the input shaft and handle during movement of the handle from the second position to the first position.

15. The landing gear of claim 1 wherein the first connection provides for a transfer of torque between the handle and the input shaft.

16. The landing gear of claim 1 further comprising a second connection for connecting the handle to the input shaft that provides for a transfer of torque therebetween.

17. The landing gear of claim 16 further comprising a first engaging portion on the input shaft; and a second engaging portion on the handle; and wherein the first and second engaging portions are disengaged when the handle is in the second position and engaged when the handle is in the first position to provide the second connection.

18. The landing gear of claim 17 wherein one of the input shaft and handle defines an opening in which the engaging portion of the other of the input shaft and handle is engageably received when the handle is in the first position.

19. The landing gear of claim 18 wherein the opening is non-circular.

20. The landing gear of claim 17 wherein:
one of the input shaft and handle comprises a clevis comprising first and second spaced legs extending from an intervening base;
the other of the input shaft and handle extends between the legs;
the base defines an opening in which the engaging portion of the other of the input shaft and handle is engageably received when the handle is in the first position;
the first leg defines a first slot which is elongated in a first direction;
the second leg defines a second elongated slot parallel to the first slot; and further comprising:
a rod extending through the first and second slots so that the handle is slidable between the first and second positions in the first direction with the rod disposed in the first and second slots.
